(19) United States
(12) Patent Application Publication
(10) Pub. No.: US 2016/0180381 A1
(43) Pub. Date: Jun. 23, 2016

(54) SYSTEM AND METHOD FOR IMPRESSION PURCHASE BASED ON SKILLED AGENT

(71) Applicant: Genesys Telecommunications Laboratories, Inc., Daly City, CA (US)

(72) Inventors: Lizanne Kaiser, RIchmond, CA (US); Cliff Bell, Kalispell, MT (US); Daniel Stoops, Powell, OH (US); Herbert Willi Artur Ristock, Walnut Creek, CA (US); James Kraeutler, Cardiff, CA (US)

(21) Appl. No.: 14/577,789

(22) Filed: Dec. 19, 2014

(51) Int. Cl. G06Q 30/02

(52) U.S. Cl. CPC G06Q 30/0255; G06Q 30/0277

(57) ABSTRACT

A system and method include a demand side platform configured to manage an ad exchange. The ad exchange provides an impression to be displayed on an audience computer based on a purchase by a market processing system. A stats server connected with the demand side platform is configured to provide to the demand side server a number of agents available who meet a determined threshold skill level to handle a particular type of product or service related to the impression. A web browser is connected with the demand side platform. The demand side platform is configured to send the impression to the web browser based on a skilled agent being available that meets the threshold, otherwise to not send the impression. The web browser is configured to display the impression.

### BACKGROUND

Consumers can be targeted with advertising where the advertisements are selected and served in part due to some information that is known about the consumer or consumer group that will receive the ads. In digital advertising, advertisements can be sent on an opt-in basis meaning that the advertising is presented to consumers that may take an option of interacting with the ad, if interactive, or at least contacting the advertiser to engage further in the process of an advertisement leading to some transaction.

### BRIEF DESCRIPTION OF THE DRAWINGS

In association with the following detailed description, reference is made to the accompanying drawings, where like numerals in different figures can refer to the same element.

FIG. 1 is a block diagram of an example impression delivery network.

FIG. 2 is a block diagram of an example support side architecture for supporting the advertisement delivery network, or other delivery networks.

FIG. 3 is a block diagram of an example support side architecture for supplying right skilled resources in the advertisement delivery network, or other delivery networks.

FIG. 4 is a block diagram of an example architecture for serving impressions based on a correctly skilled agent being available to discuss the product or service of the impression with the audience computer.

FIG. 5 is a screenshot of an example service window for the agent.

FIG. 6 is a screenshot of an example call control element.

FIG. 7 is a block diagram of an example system architecture for the impression delivery network and connecting with a customer using a web voice call.

FIG. 8 is a flowchart of an example impression purchase/display based on a skilled agent availability.

FIG. 9 is a flowchart of an example dynamic resource allocation, e.g., agent allocation, based on a demand side platform.

FIG. 10 is a flowchart of an example purchase/display of an impression based on workforce management (WFM) scheduling.

FIG. 11 is a flowchart of an example ad purchase/display of an impression based on a knowledge management corpus to augment the run-time evaluation of the impression purchase and/or display decision.

### DETAILED DESCRIPTION

With the growth of the Internet network, electronic advertising, including email advertising and web page advertising, e.g., Internet search result page advertising, mobile advertising, text-based advertising, streaming TV/movie/media advertising, etc., have become vehicles for opt-in advertising and/or drive follow-up from the consumer into the organization through a variety of contact channels. Targeting methods for electronic advertising include targeting consumers based on search keyword, on-line user behavior, navigation history, profile information, likes or dislikes, survey response, GPS coordinates, etc. For electronic advertising, a consumer receiving the advertisement may interact with it to initiate a process which represents the goal of the advertisement, e.g., a sale to a consumer of a service or a product.

For purposes of explanation, the term contact center is used to refer to the contact point within the enterprise or organization that is interacting with the prospect or customer. The embodiments are not restricted to traditional contact center agents. The contact point can also include situations such as a representative in a branch, store, back office, home-based worker, field worker, outsourcer, and/or virtual agents or other forms of self-service automation, etc. Any point of contact is possible. For example, a customer experience platform (CXP) responsible for tracking and managing customer interactions is aware of that enterprise point of contact. Also, an agent is an agent of a contact center, point of contact or other enterprise representative.

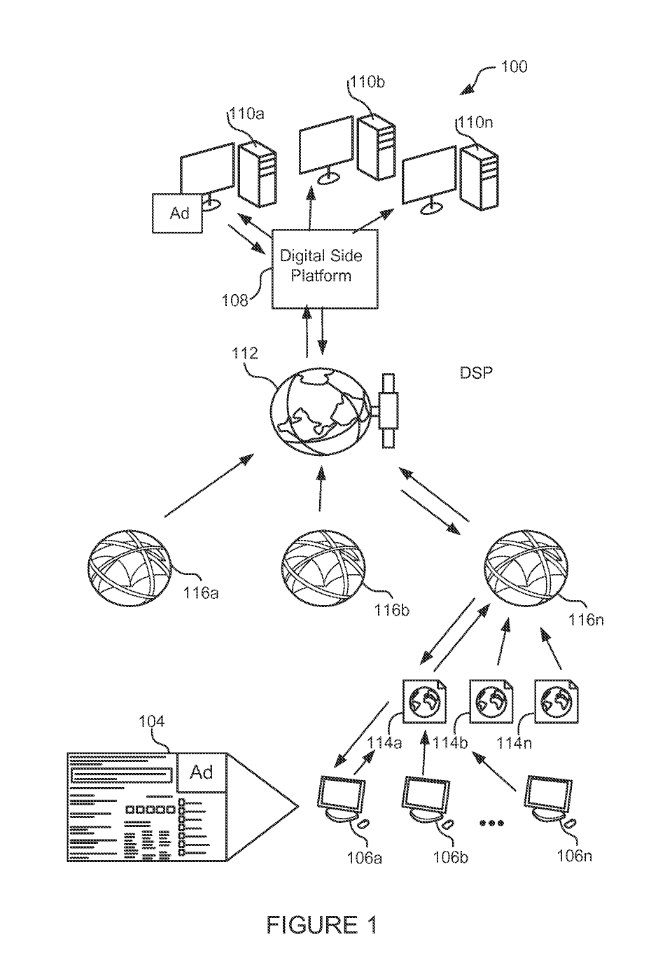

FIG. 1 is a block diagram of an example impression delivery network 100. For purposes of explanation, an online advertising platform is described, but other types of advertising platforms can be used including print advertising, radio advertising, television advertising, etc. The impression delivery network 100 may be a data packet network or network segment including a delivery network over which the impressions 104, e.g., advertisements, may be served to an audience 106a, b, n. The audience computer 106a, b, n can include a computer of a potential customer, an existing customer, etc. Broadband, digital subscriber line (DSL) services, cable, etc. may be employed in the delivery architecture.

A demand-side platform 108 allows marketers on market side computers 110a, b, n to manage multiple ad exchange and data exchange 112 accounts through an application programming interface (API). Publishers 114a, b, n of ad networks 116a, b, n make requests for bids and retrieve the impressions 104 from the ad exchange 112 to send the impressions 104 to the audience computers 106a, b, n. A publisher 114a, b, n and ad network 116a, b, n can include a search engine provider, e.g. YAHOO, or other publisher. An exemplary ad exchange 112 is the DoubleClick Ad Exchange. Real-time bidding for display of the impressions 104 online can take place within the ad exchanges 112. By utilizing the demand side platform 108, the publishers 114a, b, n can manage their bid requests for the available advertising space and the pricing for the impressions 104, and the market side computers 110a, b, n can manage the advertisements that they are layering on to the website to target the audiences of the audience computers 106a, b, n. The market side computers 110a, b, n can perform various functions including design of marketing advertisements campaigns and arbitration of advertisement assignments to publishers, e.g., automated, based on rules. Logic for arbitration can include determining an actual current presence of end users and pricing. If the impression 104 includes an option for a communication with the representative 206, e.g., a chat or a call, then pacing can be implemented. Pacing is related to hit rate, e.g., percentage of accepted offers, which may vary across publishers 114a, b, n, and can depend on further parameters including time of day, season, etc., as described below. The winning bid from the market side computers 110a, b, n gets its impression 104 displayed.

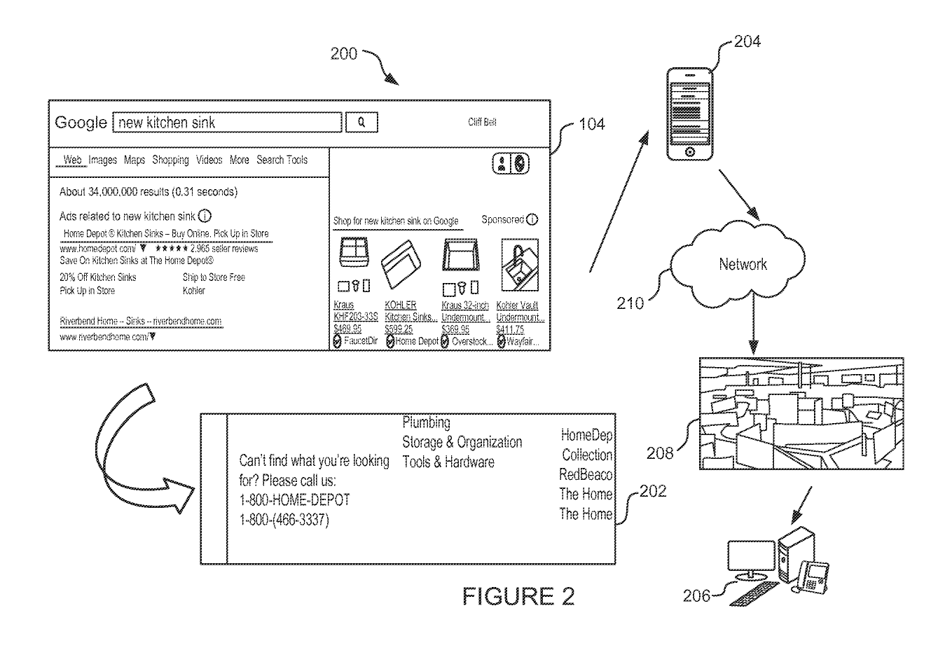

FIG. 2 is a block diagram of an example support side architecture 200 for supporting the impression delivery network 100, or other delivery network. Digital advertising purchases can be evaluated based on historical campaign data, web usage criteria, page traversal, and other data. The demand side platform 108 allows market side computers 110a, b, n to optimize their bids based on key performance indicators, e.g., effective cost per click (eCPC), effective cost per action (eCPA), supply-side stock inventory availability, etc. This ensures the right product or service is offered to a particular audience computer 106a, b, n. The enterprise utilizing the market side computers 110a, b, n may want to deliver the right-skilled resource to timely support the sales or service opportunity without the audience of the audience computer 106a, b, n having to wait more than a determined amount of time. As described in more detail below, this can be addressed by proper pacing of the advertisement campaign, matching generated inbound traffic with available resources, e.g., representatives 206.

For example, the impression 104 may include contact information 202 so that the audience can use a communication device 204 to connect over a network 210 with an agent 206 at a contact center 208. The communication device 204 can include a mobile phone, a landline phone, a computer, etc. The network 210 can include a public switched telephone network (PSTN), including for example, telephone lines, fiber optic cables, microwave transmission links, cellular networks, communications satellites, undersea telephone cables, etc., interconnected by switching centers, and/or a local area network (LAN), a wide area network (WAN), e.g., the Internet, a city area network (CAN), a metropolitan area network (MAN), etc.

The enterprise may be over-advertising or under-advertising and thus driving inappropriate volumes of prospect or customer interactions into their contact center 208, or other customer-facing resources, when there are not the right skilled resources available to handle those sales or service inquiries driven by the impressions 104 that have been purchased and displayed. In can be better for the digital ad purchases to take into account the availability of correctly skilled agents 206 to engage the audience, answer questions, and close a sale. One scenario can be oriented towards ensuring a right-skilled agent 206 is available when a dynamic chat or web callback session is offered. Other scenarios are possible. For example, the interaction can start with chat, and then a voice channel is added, or vice versa. The dynamic web invitations are presented on the enterprise's own website, after the customer may have already landed on this site from some other website source. Other scenarios for ad purchases try to generate as much traffic as possible, in hopes of creating the best percentage and widest funnel of impression click through rate (CTR) to ensure the highest number of potential sales. It may be preferable to ensure that enough right skilled resources are available to connect with the audience, e.g., by matching agent skill availability and/or skill level at the contact center 208 with the ad-spend. This can be particularly true for high-value, high complexity, high advertising sales-cost sales where an available, expert agent can increase the chances of closing a sale based on the advertised product or service. What is described herein, is an ability to target ad impressions/purchases based on supply-side skilled resource availability, e.g., availability of skilled mortgage loan specialists, to improve on the way that some ad impression/purchase processes reference supply-side stock inventory availability, e.g., availability of number of particular type of widgets that can be sold.

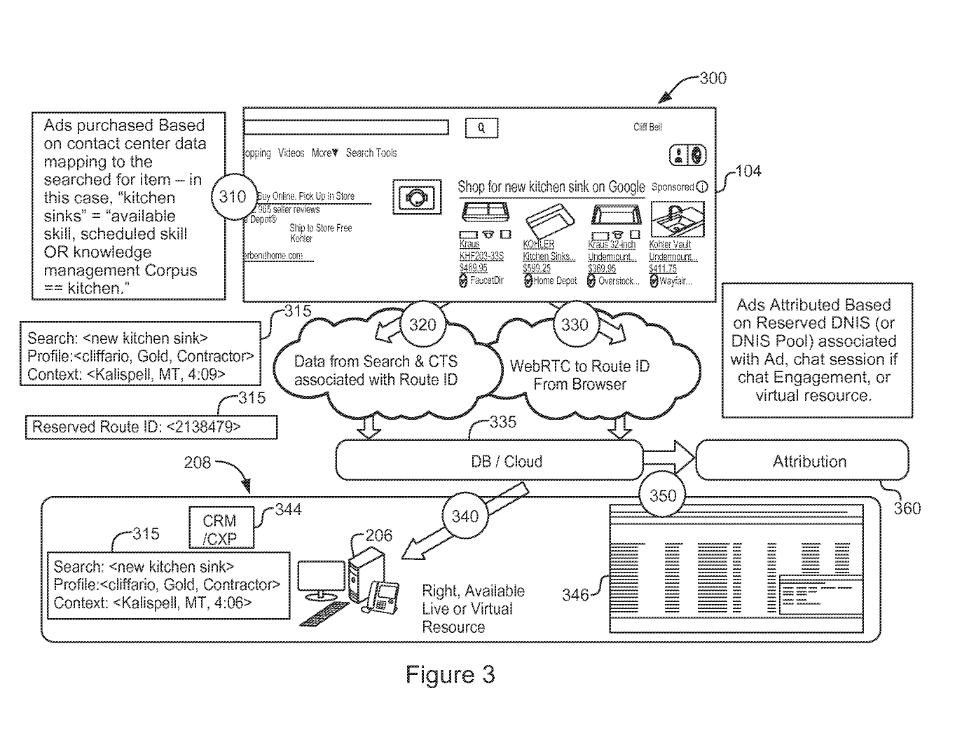

FIG. 3 is a block diagram of an example support side architecture 300 for supplying right skilled resources, e.g., agents 302, in the impression delivery network 100, or other delivery networks. The enterprise can set an advertisement budget to determine a number of impressions 104 to purchase. The impressions 104 can be purchased based on data received from the contact center 208, e.g. regarding an availability of agents with the skills and skill levels to converse to the audience about the impression 104 (310). The audience computer 106a, b, n searches for a product or service, e.g., for kitchen sinks. The enterprise can purchase an impression 104 based on a pool of agents 206 of the contact center 208 being available, e.g., with an available skill and skill level or a scheduled skill for kitchen sinks, or a knowledge management corpus at the contact center 208 being available and having the skill and/or knowledge to discuss kitchens. Availability and skill data received from the contact center 208 can be mapped to the searched for item to determine whether or not to purchase the impression 104. Availability can mean immediately available or available within a determined amount of time, e.g., in the near future. Publisher 114a, b, n, can place the impression 104 in the search results, e.g., in a search result list, of the audience computer 106a, b, n. The market side computers 110a, b, n may send impressions 104 to the publishers 114a, b, n in different modes, e.g., one-by-one, in batches (determined fixed number), for fixed time slots (but unlimited number), or any combination thereof. The publisher 114a, b, n can adjust the placing for each such mode.

The audience computer 106a, b, n can be used to select, e.g., click on, the impression 104 in the search results and be directed to a website of the seller enterprise. The website can encourage the audience to reach out to the contact center, e.g., “Agent waiting by to help you!,” by dialing the provided phone number. Alternatively, the website can encourage the audience to reach out by displaying the call number or chat link in the impression 104, without the audience 106a, b, n having to click it. For each impression 104, data 315 can be collected about search that leads to the impression 104 to be served, and the click through seller (CTS) data associated with the route identification (ID) (320). Additionally or alternatively, the audience computer 106a, b, n can be provided with a web browser link to connect with the agent 206 of the contact center 208. For example, WebRTC provides web browsers with Real-Time Communications (RTC) capabilities via simple JavaScript APIs. The WebRTC route ID information can be collected from the browser (330). The route ID and data from the search and CTS can be stored in a database, e.g., a local or remote database or distributed databases, and/or the cloud 335. Collected data 315 can include search information, e.g., about the type of product or service, profile information, e.g., audience ID, level of service, and type of audience, and context information, e.g., location of the audience member, time of the contact, etc.

The call or web browser communication along with the collected data 315 is sent to and/or accessed by the contact center 208 (340). At the contact center 208, a customer relationship management (CRM) system and/or a Customer Experience Platform (CXP) 344, an example of which is a GENESYS Customer Experience Platform for managing customer interactions, possibly further enhanced with a GENESYS Conversation Manager capabilities such as context services and business rules, can be used to manage the contact center interactions with the customer. Other platforms can be used. The CRM and/or CXP 344 organizes, automates and synchronizes sales, marketing, customer service, and technical support. Calls and browser interactions are answered by the agent 206 or placed in a queue to wait for a next available agent. A service window 346 can display the queue to the agent 206. The impression can be attributed, for example, based on a reserved dialed number identification service (DNIS) associated with the impression 104 for a call (which may be a full phone number DNIS and/or a unique extension number appended to the DNIS), and/or based on a session for a chat and/or web callback engagement via the browser or for a virtual resource (350). If the pool of reserved numbers is limited and reused in a cyclic way then additionally a timeslot for calling can be given to preserve an association with the triggering context. The agent 206 helps the customer to resolve an issue or make a purchase. When the agent 206 becomes available then the call or browser interaction is removed from the queue.

Referring also to FIGS. 1 and 2, the impression 104 is targeted to the agent pool 206, or other skilled resource, using real-time availability information. Run-time evaluation occurs for the impression 104 purchase and/or display decisions, e.g., as part of ad bidding via the demand side platform 108. The run-time evaluation takes into account the availability of agents 206 with particular skill-sets, e.g., a set of one or more desired skills for handling that type of interaction/sales opportunity, and a potential proficiency level per skill. The demand side platform 108 or third party data platform takes into account attributes such as product stock availability when determining whether or not to present a particular impression 104, along with the skilled resource availability, e.g., a skilled agent stock availability, in determining the impression purchase/display decision.

For example, a home buyer uses a web browser to do a keyword search for “mortgage rates.” The bank enterprise wants to display impressions 104 for its mortgage loans, but only when skilled mortgage loan officers are available to handle potential inquiries. The ad network 116a, b, n can send the audience's search information to the ad exchange 112, which coordinates with the demand side platform 108 to determine the appropriate impression 104 to display. This process may involve ad bidding based on various available, correctly skilled agents 206. The bank's contact center 208 sends the demand side platform 108 the status of its availability of mortgage-skilled agents 206, so the demand side platform 108 and ad exchange 112 can take this into account when determining whether it is a good time to present an impression 104 and/or which impression 104 to present, and/or how much to pay for the impression 104 based on agent skill level, e.g. higher skilled agent availability would indicate higher bid value.

In this way the bank or other enterprise can quickly and simply adapt their purchase/display of impressions 104 to when they have the agent skill-set and availability metric to facilitate fulfillment. A business value of purchasing/displaying impressions 104 for mortgage loans is high when there are experts available to handle direct chats or phone calls related to these products. Otherwise, a bulk advertisement purchase that does not determine what resources are available can generate customer activity that may not be efficiently captured, due to lack of skilled agent resources. In addition, for high-value items, e.g., insurance, mortgages, legal, financial services, medical, high technology, banking, e.g., where the Cost-Per-Click (CPC) for advertising based on the keyword is higher than other keywords, it can be beneficial to ensure the right-skilled resource is available to support an impression 104 that is delivered to the audience computer 106a, b, n. A sale attribution regarding whether or not the sale occurred and whether the customer wants to be called back can be added to an attribution tool 360 after the purchase of the impression 104 has happened to aid with subsequent resource capacity planning and forecasting.

Advantages of serving impressions 104 based on an available and correctly skilled agent 206 can include cost savings due to reduced marketing spend on impressions 104 by the enterprise only paying for ad volume in line with available skilled agent 206 resourcing. Cost savings can also occur due to operational optimization, e.g., labor cost reduction by being able to better forecast, schedule, and utilize skilled workforce. Revenue can be improved due to higher sales closure rates, e.g., as a result of a more relevant and timely connection between the impression 104 and the interaction with a skilled agent 206 who can close the sale or deliver effective service. The customer experience can be improved and customer effort lowered. The employee experience can also be improved by being able to engage with better sales leads, and interacting with more engaged prospects and loyal customers. Deflection to competitors can also be reduced by not enticing customers to action when the correctly skilled agent 206 within the contact center 208 is not available to handle the volume of interactions.

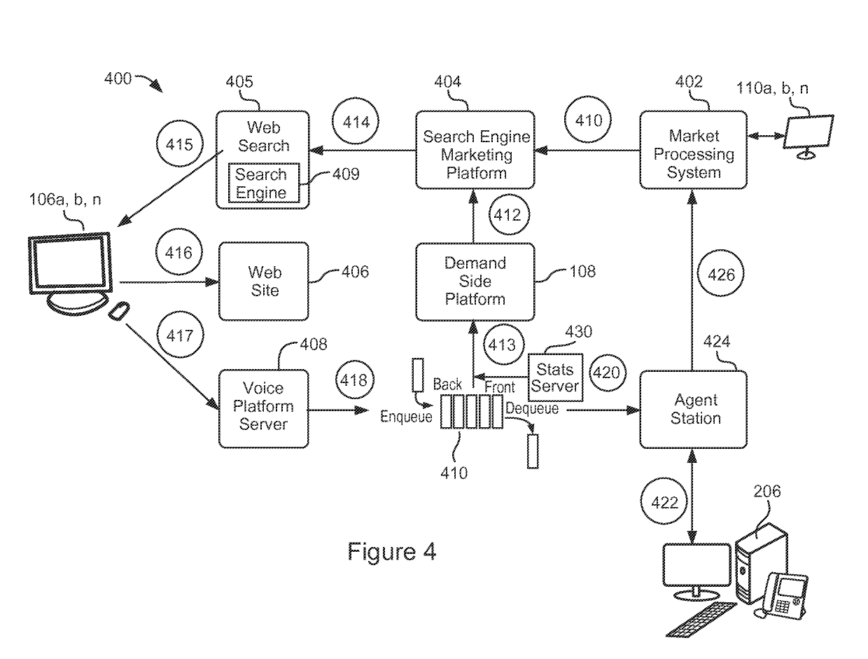

FIG. 4 is a block diagram of an example architecture 400 for serving impressions 104 based on a correctly skilled agent 206 being available to discuss a product or service with the audience for the impression 104. The available agent 206, for example, is one that is available within a determined time period before or after serving the impression 104. Additional or alternative to waiting to send an impression 104 based on information that the correctly skilled agent 206 became available, a bid amount may be higher to send the impression 104 when the agent 206 can handle premium services and products, e.g., insurance, mortgages, legal, financial services, medical, high technology, banking, etc., than if that type of agent 206 is not available within a determined time period of serving the impression 104.

A market processing system 402 provides digital marketing technology that offers email, web, mobile, streaming and/or other electronic/Internet based marketing campaign management tools to the market side computers 110a, b, n. A search engine marketing (SEM) platform 404 requests advertisement bids and volume, e.g., from the demand side platform 108 (412). The search engine 404 can include the ad exchange 112 of FIG. 1. The demand side platform 108 compares current queue 410 statistics with a total number of skilled agents 206 to determine an availability of skilled agents 206, e.g. an inventory of available, skilled agents and skill levels (413). Data for the available agent 206 may be stored in a stats server 430 of the contact center 208. The available, skilled agents 206 may be determined as agents 206 meeting a determined threshold skill level to handle particular types of products and/or services related to the impression 104. The market processing system 402 sends impressions 104 to search engine marketing platform 404 (410), e.g., via an email link or to be displayed during a web search 405. The web search 405 can include a search engine 409 which places the impressions 104 in search results based on the determination by the demand side platform 108 of available skilled agents 206.

For example, the audience computer 106a, b, n searches for a product or a service via a web browser. The search engine marketing platform 404 sends the impressions 104 to the web browser during a web search (414). In the context of a search, a search engine 409, e.g., ad networks 116a, b, n and publishers 114a, b, n of FIG. 1, can determine an impression 104 for the audience computer 106a, b, n based on attributes provided by the market side computers 110a, b, n (415). Additionally or alternatively, the impression 104 can be placed on a web page during web browsing, without the need for a search. In one example, the impression can be placed on the page based on information obtained from cookies. The attributes can include one or more of a location of the target audience, e.g., audiences living in the Midwest, a determined age range, a determined gender, a determined net worth, a determined language, etc. Included with the attributes can be a customer identifier and/or a scoring number. The search engine 409 can send the attributes with the impression 104 and/or send a customer number that is associated with the attributes, e.g., via lookup table.

The audience computer 106a, b, n can be used to click on the impression 104 in the search results, or otherwise engage the impression 104, and the browser is connected to a website of the enterprise. The customer can consider the product or service by viewing the website 406 (416) and/or decide to talk to the contact center agent 206 by phone (417). The website can encourage the customer to reach out to the contact center 208 with an “Agent waiting by to help you!” by dialing a phone number. A voice platform server 408 can answer the call the place the call in the queue 410 (418) to be picked by an agent 206 (420). The agent 206 can answer the call at an agent station 424 (422). The agent station can include a phone and a computer, the computer including a processor and memory. The call can be made in various media channels, including voice, chat, text, video, schedule contact/appointment, etc., both separate and combined. The call can be an inbound call from the customer to the agent 206, or an outbound call, e.g., the agent 206 initiating a call with the customer and/or returning a call to the customer.

An exemplary voice platform server 408 is a GENESYS voice platform (GVP) server. An interactive voice response (IVR) server which allows a computer to interact with during a call with the customer can be used to help answer the calls and place the calls in the queue 410, e.g., using dual tone-multi frequency (DTMF) tones input via a keypad. The voice platform server 408 answers the call and places the caller in the queue 410 and when the agent 206 becomes available then the audience member is removed from the queue 410. The agent 206 helps the customer to resolve an issue or make a purchase, etc. Alternatively, in certain scenarios the IVR may be sufficient to finish the sale, without need for a live representative 206. Since IVR resources are also limited, e.g., a number of concurrent media control platform (MCP) ports is limited, a pacing of when to place the impressions 104 can be required.

The agent station 424 can connect with the market processing system 402 to feed back call data and sales conversion data to the market processing system 402 (426). In addition to the collected data 315 described in FIG. 3, e.g., about the type of product or service, profile information, e.g., audience ID, level of service, and type of audience, and context information, e.g., location of the audience member, time of the contact, etc., the agent station can provide call data. The call data along with the customer ID can include negative and positive outcomes of the customer engagement, e.g., whether there was a sale, whether there was not a sale, whether the caller stated they would like time to consider the product or service and they would call back, whether the caller wants time to think about the product or service and a return call, etc. The data from the agent stations 424 can inform the market side computers 110a, b, n that the caller is expecting a follow-up call and allows for estimated hit rates, which can be important for tuning campaign pacing.

The market processing system 402 can utilize the fed back call data to set advertising budgets, determine a number of impressions 104 to delivery, determine where to deliver the impressions 104, etc. By targeting impressions 104 in ways that yield better results, this can improve advertisement fulfillment and cost reduction. In this way, attributes that would otherwise only be available to the contact center 208 are available to the market side computers 110a, b, n. The fed back data (426) can result in a smaller amount of unique, temporary numbers needed per advertising campaign since the market processing system 402 does not have to use a different phone number to distinguish between impressions 104. Additionally or alternatively, the contact center 208 can feed back word-of-mouth effects, e.g. customer communicating about campaign in social media, to the market processing system 402. A social media connector watching for actionable events can capture the data fed back to the market processing system 404. The fed back data can be combined with inbound marketing to try to cross-/up-sell to inbound customers who are not aware of campaigns.

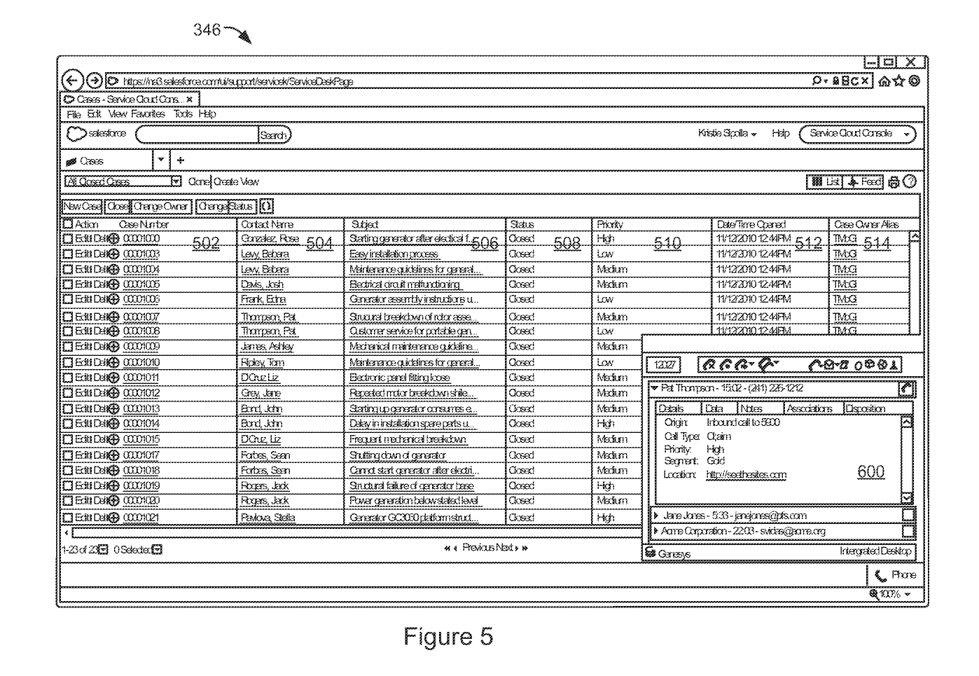

FIG. 5 is a screenshot of an example service window 346 for the agent 206. At the agent station 424 the service window 346 can be displayed to the agent 206 to help manage cases handled by the contact center 208. For example, when the audience calls the contact center 108 a case can be opened. The service window 346 includes data regarding the cases, including a case number 502, a caller's name 504, a subject 506, a status 508, a priority 510, a date and time that the case was opened 512, and a case owner 514. The service window 346 can provide information to the agent 206 regarding cases that the agent is handling, including cases opened based on a call from the audience as described above. Overlaying the service window 346 can be a call control element 600 to manage inbound/outbound calls, emails, chats, texts, etc., e.g., from/to the audience. Information from the service window 346 can be fed back to the market processing system 402.

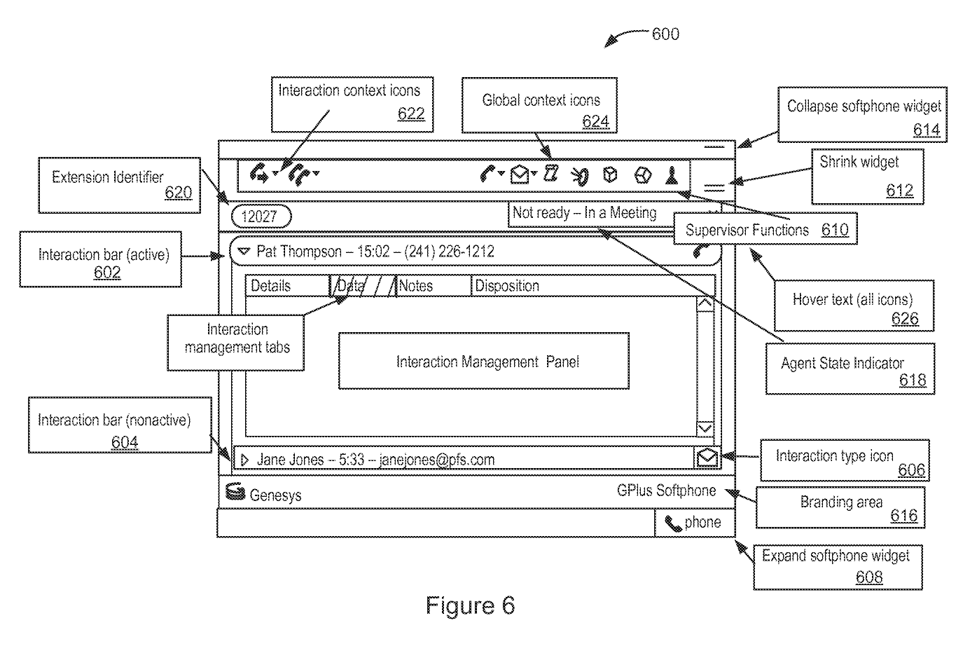

FIG. 6 is a screenshot of an example call control element 600. An active interaction bar 602 includes identification data, including a name of the caller, a time of the call, a telephone number, etc. An inactive interaction bar(s) 604 includes a name of the caller, a time, a telephone number for texts and call, or an email address for chats and emails. The call control element 600 can also indicate an interaction type 606, e.g., call, text, email, chat, etc. Other information can be included about the caller, including priority data, whether the caller was prompted by an impression 104, whether the caller is a return caller, etc. The call control element 600 can include user interface icons for the agent 206, including an expand softphone widget 608, a supervisor function 610, a window shrink widget 612, a collapse softphone widget 614, etc. Other indicators can include a branding area 616, an agent state indicator 618, an extension identifier 620, interaction context icons 622, and global context icons 624, etc. Hover text 626 can be displayed for the widgets and icons, etc. to identify the widgets and icons when the pointer is moved over the widget or icon. Information from the call control element 600 can be fed back to the market processing system 402.

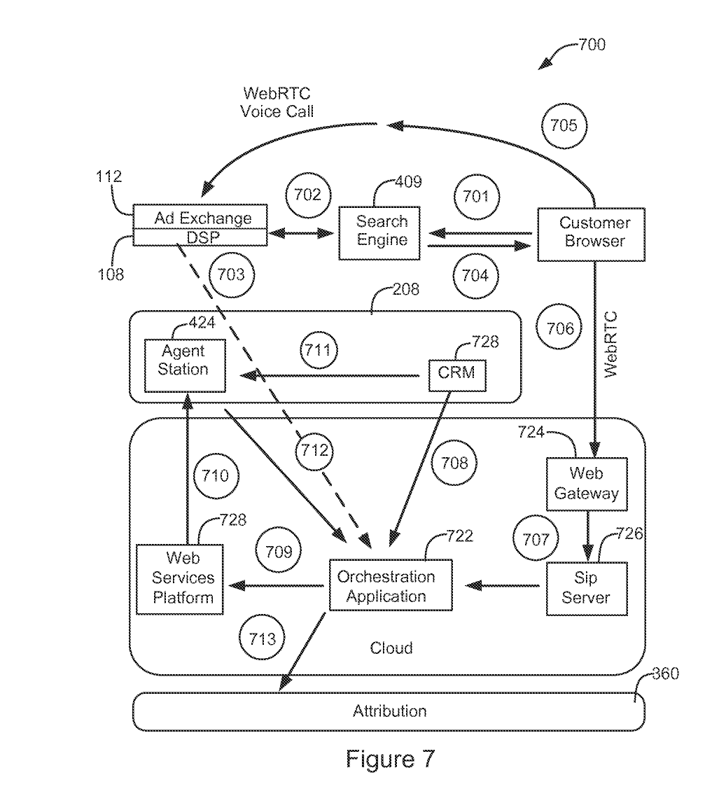

FIG. 7 is a block diagram of an example system architecture 700 for the impression delivery network 100 and connecting with a customer using a web voice call. A browser 720, e.g., of the audience computer 106a, b, n, can be used to make a search request for a service or product (701). Additionally or alternatively, the impression 104 can be placed on a web page during web browsing, without the need for a search. Additionally or alternatively, an email or text message, etc. can be sent to the audience which contains a link to a website of an enterprise. The search engine 409 contacts the ad exchange 112 which connects with the demand side platform 108 to request an advertisement bid (702). The demand side platform 108 requests a live resource availability, e.g., representative inventory status from an orchestration application 722 (703). Statistical algorithms can be used to leverage observed/estimated hit rate and predictive or progressive resource availability prediction. The orchestration application 722 can be included in a contact center 208. The contact center 208 is described as a cloud architecture but can include other architectures. The orchestration application 722 provides the inventory status of agents 206 having a determined skill or skill is available to communicate with the audience.

The search engine 409 returns search results plus an impression 104 with an embedded WebRTC button for skilled, available agent 206 (704). The WebRTC is used for explanation purposes and other real-time communication systems can be used. The audience pushes the WebRTC button and makes a WebRTC call to the contact center 208 (705). A web gateway 724 converts the incoming call into a SIP server 726, e.g., manufactured by GENESYS COMMUNICATIONS LABORATORIES, INC., or other interface server between the telephony hardware and software at the contact center 208 (706). The SIP server 726 attaches the audience data to the call (707). The orchestration application 722 receives the call and data from the SIP server 726, attaches any additional context information related to the call to the customer relationship management (CRM) server and/or customer experience platform (CXP) 728 (708), e.g., manufactured by GENESYS COMMUNICATIONS LABORATORIES, INC., or other customer relations server, and routes the call to an agent station 424 that is logged in and available through a web services platform 728 (709). The agent station 424 includes an agent 206 that is available and skilled to handle the call. The web services platform 728 alerts an agent desktop of the call (710). The agent 206 accepts call and pulls customer record from the CRM and/or CXP 728 (711). The call disposition is sent to orchestration application (712) and the disposition can generate the conversion action in the attribution tool 360 (713). The conversion action information can be sent from the contact center 208 to the marketing processing system 402, e.g., as described in FIG. 4.

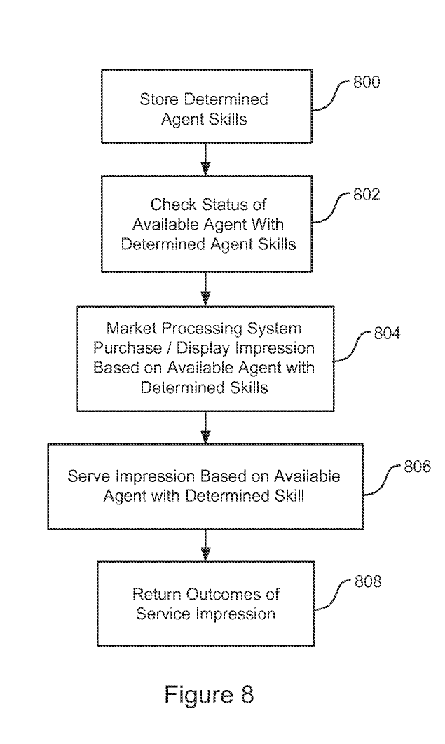

FIG. 8 is a flowchart of an example impression 104 purchase/display based on a skilled agent availability, for example using the systems described above or other systems. A run-time evaluation of the impression 104 purchase and/or display decision is augmented, e.g., as part of ad bidding via ad exchanges 112 and DSP's 108, by taking into account the availability of agents 206 with particular skill-sets and skill levels in the rule criteria. A database can be used to store a set of one or more determined skills of the agent 206 for handling a type of interaction/sales opportunity, and/or a proficiency level per skill (800). The DSPs 108 takes into account the available agent skills, along with other attributes such as product stock availability (802). For example, for active agents 206, the demand side platform 108 takes into account skilled resource availability, e.g., expert stock availability, in determining impression 104 purchase/display. The market processing system 402 can use this rule to dynamically purchase/display impressions 104 based on when the right-skilled agents are available to support potential customer contacts driven by the impression 104 (804). The impression 104 is served based on an agent with a determined skill being available at the time of serving the impression 104, and the impression is otherwise not served (806). A skilled agent 206 being available can increase the chance that the customer will have a good customer experience and purchase the service or product.

For example, a home buyer uses a browser of an audience computer 106a, b, n to do a keyword search for “mortgage rates.” A bank enterprise wants to display impressions 104 for its mortgage loans on this audience, but only when skilled mortgage loan officers are available to handle potential inquiries. The ad network 116a, b, n sends the audience search information to an ad exchange 112, which coordinates with the demand side platform 108 to determine the appropriate impression 104 to display according to the various attributes and business rules. This process may involve ad bidding, for example. The contact center 208 for the bank sends the demand side platform 108 the status of its available mortgage-skilled agents, so the demand side platform 108 and ad exchange 112 can take this information into account when determining which impression 104 to present and/or how mush to pay for the impression 104. After the interaction with the customer, the contact center 208 can return the outcome of serving the impression 104, e.g., a sale, no sale, the potential customer will call back later, the potential customer wants to be called back later, etc. (808). Advantages include cost savings due to improved marketing attribution and improved insights can guide future advertisement spending more effectively.

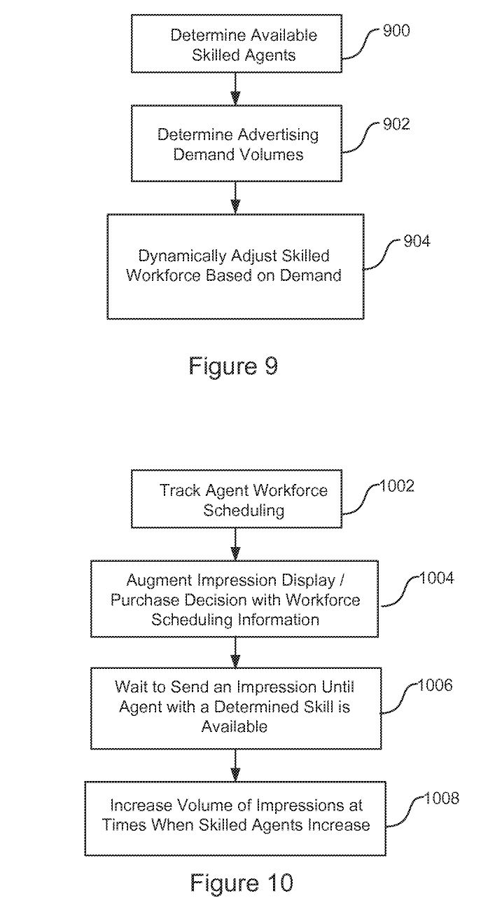

FIG. 9 is a flowchart of an example dynamic resource allocation, e.g., agent 206 allocation, based on a demand side platform. An enterprise's resource allocation, e.g., within a contact center 208 or other customer-facing enterprise, can be dynamically adjusted to a particular activity or skill-set, e.g., a set of one or more determined skills for handling that type of interaction/sales opportunity, and/or proficiency level per skill based on a current advertising demand (900). For example, near-real-time advertising demand volumes can be based on specified web user attributes, keyword searches, and online behavior, can be provided by the digital ad exchanges 112 and/or DSPs 108, e.g., as part of impression 104 bidding back to the enterprise requesting impression 104 placement (902). This allows an enterprise to dynamically adjust the skilled workforce allocation, e.g., via the routing logic and/or workforce scheduling adjustments, to meet fluctuating online volume patterns and capture potential advertisement demand (904).

This allows contact centers 208, and other customer-facing resources, to more effectively utilize available resources, applying them to the most valuable opportunity in the moment. In one implementation, when potential ad-traffic is high, other contact center interactions may be able to wait longer in queue, so that skilled agents 206 can give highest priority to ‘hot’ advertisement leads. For example, the market processing system 402 is able adjust a caller wait time based on a type of interaction, e.g., agents 206 are to prioritize the handling of calls so that there is a shorter wait time for hot leads and longer wait time for other interactions. For example, a home buyer uses a web browser of an audience computer 106a, b, n to do a keyword search for mortgage rates. A bank wants to display impressions 104 for its mortgage loans on this audience computer 106a, b, n, but only when it has skilled mortgage loan officers available to handle potential inquiries.

The impression delivery network 100 sends the audience's search information to the ad exchange 112, which coordinates with the demand side platform 108 to determine the appropriate impression 104 to display, e.g., through ad bidding, according to determined attributes and business rules. The contact center 208 for the bank sends the demand side platform 108 the status of its availability of mortgage-skilled agents, so the demand side platform 108 and ad exchange 112 can take this into account when determining which impression 104 to present. The demand side platform 108 can alert the enterprise that there is currently even higher volumes of potential mortgage prospects for this impression 104 than the contact center 208 currently has mortgage-skilled resources available to address. The contact center 208 can leverage this near-real-time impression-demand insight to adjust its current skilled resource allocation, e.g., by dynamically or manually adjusting a higher number or agents 206 to be available for mortgage-skilled interactions.

An advantage is that the contact center 208 can in near-real-time adjust the number of skilled-agents 206 currently available from a lower-value activity/skill-set to a higher-value activity/skill-set associated with the a impression 104 in order to capture this marketing opportunity. It can be beneficial to ensure the right-skilled agent 206 or other resource is available to support the impression 104 that is delivered to audience computer 106a, b, n, and that agents 206 are assigned where there is the best opportunity for connecting with a strong marketing lead. The contact center 208 can provide real-time awareness of detailed agent skill-sets and availability, and the ability to correlate near-real-time impression 104 demand with current skilled resource availability and scheduling.

FIG. 10 is a flowchart of an example purchase/display of an impression 104 based on workforce management (WFM) scheduling. The contact center 208 can obtain a tracked WFM scheduling of an agent 206 (1002). The contact center 208 can augment the run-time evaluation of the impressions 104 purchase and/or display decision, e.g., as part of ad bidding via the ad exchanges 112 and demand side platform 108 by taking into account the enterprise's workforce scheduling information of agents with particular skill-sets in the rule criteria (1004). For example, the presentation of a particular type of impression 104 may be suppressed if the appropriately skilled agent 206 is about to become unavailable per their workforce schedule (1006). Additionally or alternatively, impression 104 volumes may be increased at times when certain types of skilled agents 206 are more heavily staffed (1008). This approach allows an enterprise to dynamically match the purchase/display of impression 104 decisions with its skilled workforce schedules.

For example, a home buyer uses a browser of the audience computer 106a, b, n to do a keyword search for mortgage rates. A bank wants to display impressions 104 for its mortgage loans on the audience computer 106a, b, n, but only when skilled mortgage loan officers are available to handle potential inquiries. The search engine 409 sends search information to the ad exchange 112, which coordinates with the demand side platform 108 to determine the appropriate impression 104 to display according to various attributes and business rules. The contact center 208 sends the demand side platform 108 the status of its availability of mortgage-skilled agents 206, and the demand side platform 108 and ad exchange 112 take this into account when determining which impressions 104 to present.

Based on WFM scheduling, the bank's contact center 208 takes into account that a mortgage-related interaction takes on average 15 minutes, but that all mortgage-skilled agents 206 are about to become unavailable, e.g., go on break, into a meeting, into training, end of work day, etc. within 5 minutes. Therefore, the bank's contact center 208 alerts the demand side platform 108 to suppress or delay the impression 104 purchase/display, since it determines that the contact center 208 will not have the skilled agent 206 available to meet this demand if the impression 104 were offered. Alternatively, the contact center 208 may determine based on its workforce planning that the contact center 208 will have a higher number of mortgage-skilled agents scheduled to work at an alternative time, e.g., on Monday morning, so it can notify the demand side platform 108 to purchase/display a greater number of mortgage-ad impressions during this time period. An advantage is that the right-skilled resource is available to support an advertisement that is delivered to an audience computer 106a, b, n, and that the purchase/display volumes of impressions 104 are in line with the schedule of available skilled resources.

Additionally or alternatively, staffing needed for serving the expected increase in traffic can be predicted, using similar means as WFM for traffic prediction based on history data, e.g., for same or similar campaign in the past. The demand side platform 108 can also take into account also timing, e.g., time of day, day of week, etc., which correlates with engagement ratio, e.g., hit rate, and latency of response. A required skill mix of the agents 206 can be also predicted, depending on campaign specifics. Adjustments can be made during campaign run, e.g., the WFM can adjust staffing intraday by comparing predicted and actual traffic. In addition to staffing adjustment, campaign pacing can be used to insure the skilled agent 206 is available when the impression 104 is served. Necessary information, e.g. performed staffing adjustment, can be provided to campaign management, which adjusts accordingly. Machine learning can be used for tuning models, campaign manager, traffic prediction/staffing, etc.

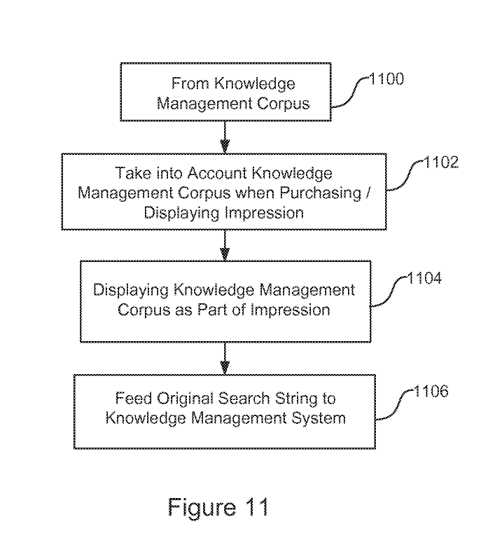

FIG. 11 is a flowchart of an example ad purchase/display of an impression 104 based on a knowledge management corpus to augment the run-time evaluation of the impression 104 purchase and/or display decision. Bidding on the impressions 104 can occur via ad exchanges 112 and demand side platform 108 by taking into account the availability of knowledge management systems with a corpus in a particular area of expertise. A knowledge management corpus is determined (1100). Knowledge management corpuses can be differentiated by customer segments. For example, the knowledge management corpus may be formed that is adept at answering questions related to financial products versus one that is skilled at addressing healthcare topics in the rule criteria. The DSPs 108 can take into account the knowledge management corpus availability, e.g., expert corpus availability, in determining purchase/display of an impression 104, in addition to attributes such as product stock availability, when determining whether or not to present a particular impression 104 (1102). The impression purchase/display rule enables the market processing system 402 to dynamically purchase/display impression 104 based on when the right-skilled knowledge management corpus is available to support potential customer contacts driven by the impression 104. Additionally or alternatively, access to the knowledge management corpus can be displayed with the impression 104 to make the impression 104 more interactive (1104). The display of the knowledge management corpus may encourage a higher click-through rate (CTR).

For example, a parent can use a web browser of the audience computer 106a, b, n to do a keyword search for “529 Plan.” A bank's contact center 208 wants to display ads for its 529 Plans on the audience computer 106a, b, n, but only if it has a knowledge management system with a robust corpus related to that topic. The search engine 409 sends the user's search information to the ad exchange 112, which coordinates with the demand side platform 108 to determine the appropriate impression 104 to display according to the various attributes and business rules. The contact center 208 sends the demand side platform 108 the status of its knowledge management corpus, so that the demand side platform 108 and ad exchange 112 can take this into account when determining which impression 104 to present to the audience computer 106a, b, n.

Additionally or alternatively, the parent's search string can be passed into the knowledge management system (1106), and the impression 104 that is presented can display the knowledge management response stating: “Answer: ‘A 529 Plan is a tax-advantaged savings plan designed to encourage saving for future college costs,’ for example, and “Next Question: connect with a 529 Specialist, or Our Website.” Therefore, the impression 104 provides a specified answer based on the keyword search term, and then engages the customer in continued dialog with the knowledge management system, a live resource, or via click-through to the enterprise's website.

The enterprise can quickly and simply adapt their ad purchase/display when they have a metric, e.g., availability of a knowledge management system with a robust corpus on a particular topic, to facilitate fulfillment. For example, a value of the impression 104 can increase when purchasing/displaying impression 104 for “529 Plans” when there is a specialized knowledge management corpus on that topic. Otherwise, a bulk impression 104 purchase that does not identify what specialized resources are available may generate customer activity that is not efficiently captured. To help manage the knowledge management corpus, the knowledge workers can be invited to handle the call or chat. This can be done through pacing of invites to knowledge workers, and keeping those who accepted for a short time in a pool of reserved knowledge workers. Queued interaction requests are matched to reserved knowledge workers. In order to not block the knowledge workers, the knowledge workers can leave the knowledge worker pool after a configurable timeout, even if no interaction was assigned. Another scenario is transfer from representative 206 to knowledge worker, e.g. a two-step or a blind transfer.

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments have been described, it can be apparent that many more embodiments and implementations are possible. Accordingly, the embodiments are not to be restricted.

1. A system, comprising:
a demand side platform configured to manage an ad exchange, the ad exchange to provide an impression to be displayed on an audience computer based on a purchase by a market processing system;
where a stats server is connected with the demand side platform, the stats server configured to provide to the demand side platform a number of agents available who meet a determined threshold skill level to handle a particular type of product or service related to the impression; and
where a web browser is connected with the demand side platform, the demand side platform configured to send the impression to the web browser based on a skilled agent being available that meets the threshold, otherwise to not send the impression, the web browser configured to display the impression.

2. The system of claim 1, further including a voice platform server, the voice platform server to receive a call based on the impression being sent.

3. The system of claim 2, further including an agent station, the voice platform server to send the call to the agent station having the skilled agent.

4. The system of claim 1, further including an agent station, the agent station handling a call from a customer based on the impression being sent.

5. The system of claim 4, further comprising the agent station configured to feed back a call data to the market processing system based on the call.

6. The system of claim 5, where the call data includes negative and positive outcomes of the call.

7. The system of claim 6, where the call data includes that a caller is expecting a follow-up call.

8. The system of claim 1, further including a web gateway configured to convert a web call sent to an agent station based on the impression.

9. The system of claim 8, further including an orchestration application connected with the web gateway, the orchestration application configured to send attribution data to the market processing system to improve customer experience.

10. The system of claim 1, where the market processing system is further configured to adjust the number of agents available who meet a determined threshold skill level based on demand for the product or service.

11. The system of claim 1, where the demand side platform is further configured to send the impression to the web browser based on workforce scheduling information.

12. The system of claim 1, where the demand side platform is further configured to send the impression to the web browser based on a determined knowledge management corpus.

13. The system of claim 12, where access to the knowledge management corpus is displayed with the impression.

14. The system of claim 1, where the market processing system is further configured to adjust a caller wait time based on a type of interaction.

15. A system, comprising:
a processor and a memory, where the memory configured to store instructions which when executed by the processor causes the processor to:
check a status of active contact center agents having a determined skill;
determine whether there is a contact center agent available having the determined skill; and
receive a call based on an impression being sent to an audience when the contact center agent having the determined skill is available.

16. The system of claim 15, the processor being further configured to send call data to a market processing system after the call is completed.

17. A method, comprising:
receiving a call based on an impression being placed on a web page, the impression being placed on the web page based on a contact center agent being available who has a determined skill to handle a call for a specified product or a service.

18. The method of claim 17, further comprising sending call data to a market processing system after the call is completed.

19. The method of claim 17, further comprising the impression being placed on the web page based on workforce scheduling information.

20. The method of claim 17, further comprising the impression being placed on the web page based on a knowledge management corpus.
